(19) United States
(12) Patent Application Publication
(10) Pub. No.: US 2008/0182088 A1
(43) Pub. Date: Jul. 31, 2008

(54) Logo

(76) Inventor: Jen-Keui Shih, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/699,466

(22) Filed: Jan. 30, 2007

(51) Int. Cl. B32B 7/10

(52) U.S. Cl. 428/200

(57) ABSTRACT

A logo comprises an adhesive layer, an elastic layer, and a coarse layer. The adhesive layer has elasticity, the elastic layer has ductility and elasticity and disposed on an upper surface of the adhesive layer, and the coarse layer is disposed on an upper surface of the elastic layer. Thereby a logo is formed and rather has ductility and elasticity.

### BACKGROUND OF THE INVENTION

1. Field of the invention

The present invention relates to a logo, and more particularly to the logo rather has ductility and elasticity.

2. Description of the Prior Art

A logo, sealed on clothing, is made by using the stencil printing method and ink printing method conventionally. Reference made to FIG. 1 is a cross-sectional view of a logo of a conventional logo. A hot melt adhesive 10a is adhered on the bottom surface of a partial totem 20a that is printed ink, and a shielding paper 30a is pasted on the upper surface of the partial totem 20a. Hence, the layer by the printing method forms the logo with certain thickness, and next, the logo is printed on the clothes by using heat transfer method.

However, thickness of the conventional logo is restrained. After the logo being printed repeatedly, the patterns sealed on clothes are gradually blurred and rugged, and poor ductility and elasticity to easily be damaged and deformed.

The inventor of the present invention recognizes the above shortage should be corrected and special effort has been paid to research this field. The present invention is presented with reasonable design to resolve the mentioned-above problems.

### SUMMARY OF THE INVENTION

It is a primary object of the present invention to provide a logo has rather elasticity and the logo is not easily damaged while extended in use.

It is another object of the present invention to provide the logo can be used in both sides.

To achieve the objectives stated above, the logo comprises an adhesive layer with elasticity, an elastic layer with ductility and elasticity disposed on an upper surface of the adhesive layer, and a coarse layer disposed on an upper surface of the elastic layer.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a cross-sectional view of a logo according to the prior art;

FIG. 2 is a cross-sectional view of a first embodiment of a logo according to the present invention;

FIG. 3 is a cross-sectional view of a second embodiment of the logo according to the present invention;

FIG. 4 is a cross-sectional view of a third embodiment of the logo according to the present invention;

FIG. 5 is a cross-sectional view of a fourth embodiment of the logo according to the present invention;

FIG. 6 is a cross-sectional view of a fifth embodiment of the logo according to the present invention;

FIG. 7 is a cross-sectional view of a sixth embodiment of the logo according to the present invention;

FIG. 8 is a cross-sectional view of a seventh embodiment of the logo according to the present invention;

FIG. 9 is a cross-sectional view of a eighth embodiment of the logo according to the present invention; and

FIG. 10 is a cross-sectional view of a ninth embodiment of the logo according to the present invention.

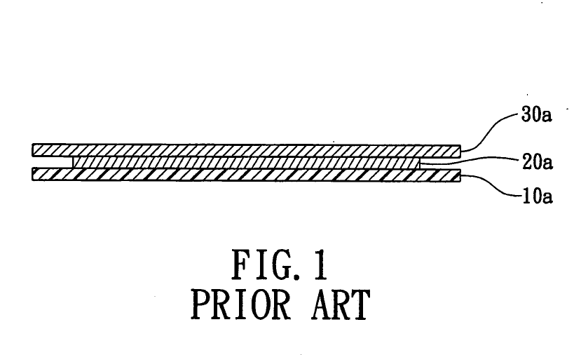

The drawings will be described further in connection with the following detailed description of the present invention.

### DETAILED DESCRIPTION OF THE PREFERRED EMBODIMENTS

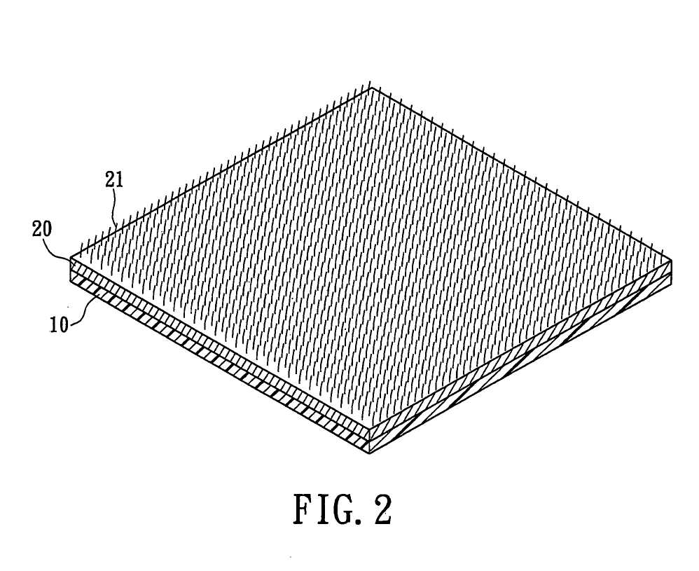

Reference is shown as in FIG. 2 which is a cross-sectional view of a first embodiment of a logo according to the present invention. The logo comprises an adhesive layer 10, an elastic layer 20, and a coarse layer 21. The adhesive layer 10 is a hot melt adhesive or a thermoplastic resin with elasticity, and the appearances of the adhesive layer 10 is designed according to desired patterns.

The elastic layer 20 is made of the material with ductility and elasticity, such as latex, polyurethane (PU), thermoplastic polyurethane (TPU), silicone, or etc., and thickness of the elastic layer 20 is from 0.05 to 2.0 millimeters and provides a good manufacture. The elastic layer 20 is disposed on the upper surface of the adhesive layer 10 using a whole way or a spread multi-block way. A knife mold is manufactured according to a pre-designed pattern form, and the elastic layer 20 and the adhesive layer 10, fixed on a jig, are stamped as the desired pattern by means of the knife mold. Also, a metal sculptured mold is made of the copper material or steel material, and the desired pattern is cut by means of the high-frequency wave or the ultrasound, even is directly cut by means of the laser.

The coarse layer 21 is disposed on an upper surface of the elastic layer 20 and formed by various ways of surface treatment. In this embodiment, the coarse layer 21 is fluff layer and the fluff layer formed by sueding processing of the upper surface of the elastic layer 20 so that the coarse layer 21 has a plurality of fluff. Because the upper surface of the elastic layer 20 is protrudingly disposed a plurality of fluff, the user has a better feel while touching the surface of the logo. In addition, the coarse layer 21 is to increase a surface area of the elastic layer 20 so as to obtain a better elasticity.

The fluff of the coarse layer 21 can be formed on the upper surface of the elastic layer 20 by flocking way or nanotechnology.

In this embodiment, the adhesive layer 10 of the logo is fused by increasing temperature and pressure for the logo to adhere the elastic layer 20 on a surface of the sealed object so that the logo is heat transformed on the sealed object, such as cloth or clothes.

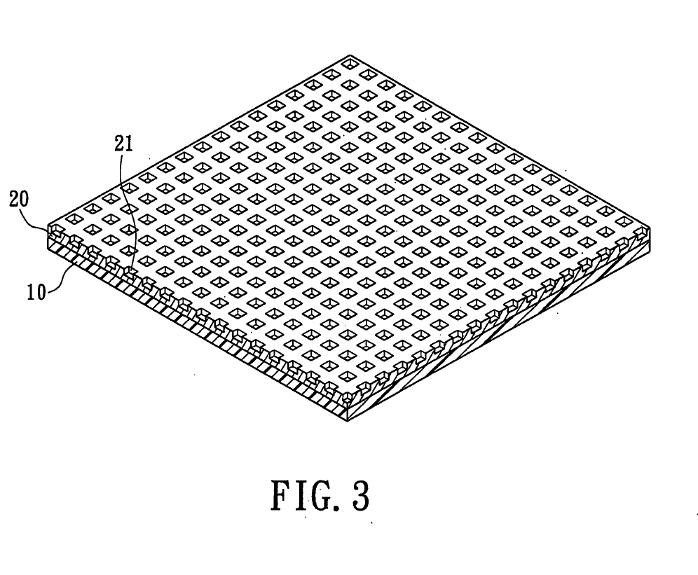

Reference is shown as in FIG. 3 which is a cross-sectional view of a second embodiment of the logo according to the present invention. The coarse layer 21 is a pattern layer and a metal sculptured mold is made of the desired patterns. Next, the surface of the elastic layer 20 is formed as texture with three-dimensional troughs by the metal sculptured mold to provide a particular surface effect due to detailed patterns and texture, and the texture of the coarse layer 21 can be cut by the high-frequency wave or the ultrasound, even is directly cut by means of the laser.

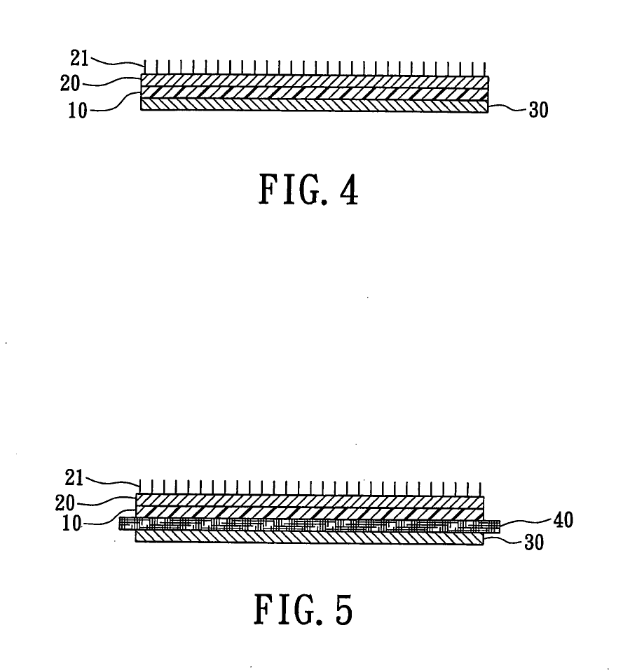

Reference is shown as in FIG. 4 which is a cross-sectional view of a third embodiment of the logo according to the present invention. The logo further comprises an effect layer 30 and adhered on a bottom surface of the adhesive layer 10 processed. Also, the logo can be stitched on the sealed so that the logo can be used in both sides. In this embodiment, the effect layer 30 can be a reflective layer formed by the reflective paint, and one side of the logo has a plurality of fluff and the other side has a reflective effect so that the logo not only has better feel but also has reflective effect.

The effect layer 30 is also a metal plating layer formed by the metal filming. Hence, the sealed objects logo will appear color, brightness, and quality after being sealed by the logo. In addition, the effect layer 30 is also a luminous layer involved fluorescent components. Hence, as the logo is sealed on the sealed objects, the sealed objects will become eye-catching by reflecting light at night.

Reference is shown as in FIG. 5 which is a cross-sectional view of a fourth embodiment of the logo according to the present invention. The logo is further combined to an elastic cloth layer 40. The elastic cloth layer 40 is a cloth with elasticity and is clipped between the adhesive layer 10 and the effect layer 30, and the elastic cloth layer 40 is used to strengthen toughness of the logo so that the logo can bear greater pulling force.

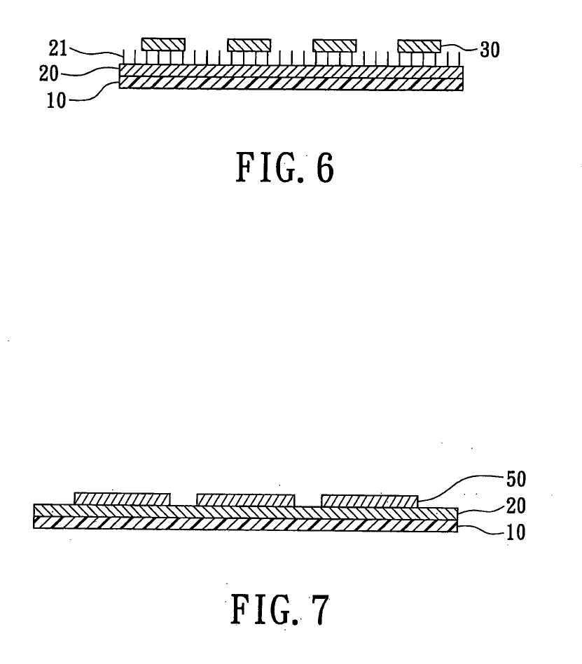

Reference is shown as in FIG. 6 which is a cross-sectional view of a fifth embodiment of the logo according to the present invention. The effect layer 30 can be partially disposed on an upper surface of the coarse layer 21 so that the surface of the logo has variations of fluff and appearance so as to increase elasticity of the elastic layer 20 and appearance of the logo. In this embodiment, the effect layer 30 can be a reflection layer, metal plating layer, or luminous layer.

Reference is shown as in FIG. 7 which is a cross-sectional view of a sixth embodiment of the logo according to the present invention. The difference to the first embodiment is that the elastic layer 20 doesn't have the coarse layer 21 on the upper surface thereof instead of an attaching layer 50.

The attaching layer 50 is a shielding paper made of the poly ethylene terephthalate (PET) or the thermally stable resin material, and the attaching layer 50 is adhered on the upper surface of the elastic layer 20 for protecting brightness and beauty of the surface patterns thereof without being damaged causing due to dust. After logo is sealed on surface of the sealed objects, the attaching layer 50 can be peeled to show three-dimensional patterns of the elastic layer 20 on the sealed objects.

Furthermore, the elastic layer 20 is further processed in following ways as desired patterns:

1. The elastic layer 20 is cut into strip shape by the cutting tool, and the desired pattern is mutually constituted by different sizes of strips;

2. The desired pattern is carved on a metal sculptured mold to manufacture a metal sculpture mold, and the surface of the elastic layer 20 is formed as texture with three-dimensional troughs; and

3. The elastic layer 20 is stamped or cut to the desired texture and pattern by the laser, high-frequency, or ultrasound.

The attaching layer 50 further has various types. For example, the attaching layer 50 can be a reflective layer formed by the reflective paint, and adhered on the upper surface of the elastic layer 20 processed. As the logo is sealed on the sealed objects, the sealed objects will become eye-catching by reflecting light at night.

The attaching layer 50 is also a metal plating layer formed by a metal filming, and adhered on the upper surface of the elastic layer 20 processed. As the logo is sealed on the sealed objects, the sealed objects will appear better color, brightness, and quality. In addition, the attaching layer 50 is also a printed layer formed by print inks, and adhered on the upper surface of the elastic layer 20 processed. As the logo is sealed on the sealed objects, the sealed objects will show various patterns and colors.

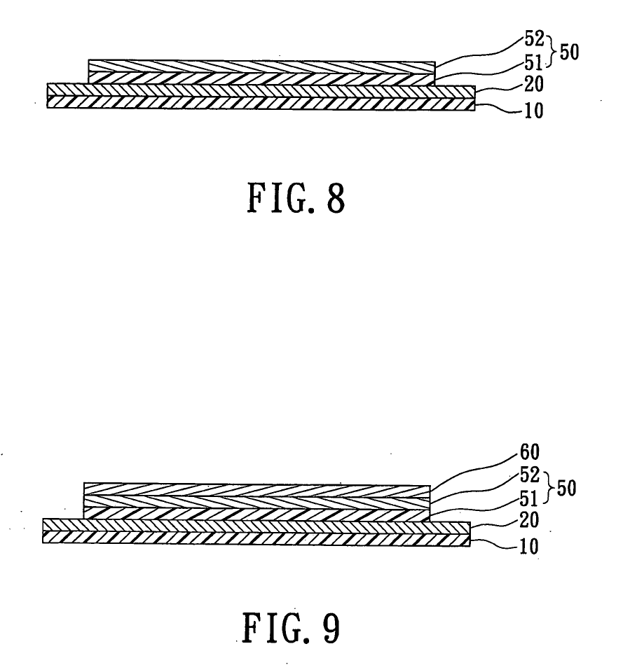

Reference is shown as in FIG. 8 which is a cross-sectional view of a seventh embodiment of the logo according to the present invention. The attaching layer 50 is another elastic layer 52 that a bottom surface thereof disposed on another adhesive layer 51. The elastic layer 52 can be processed as above-mentioned methods to the desired patterns. The elastic layer 52 is disposed on an upper surface of the adhesive layer 51 so that the elastic layer 52 is adhered on the original elastic layer 20 by the adhesive layer 51 to obtain various three-dimensional patterns and styles for the logo.

Reference is shown as in FIG. 9 which is a cross-sectional view of an eighth embodiment of the logo according to the present invention. The difference to the seventh embodiment is that another printed layer 60 is formed by printing inks printed on the upper surface of the elastic layer 52 to add patterns and colors so that the logo not only further has three-dimensional effect but also colors and styles.

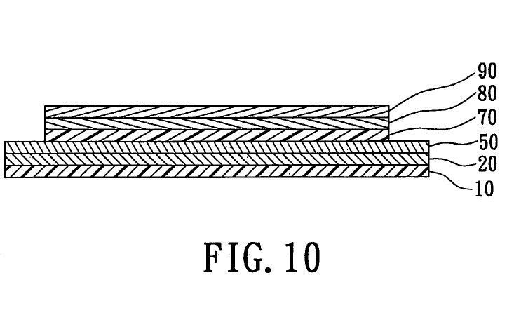

Reference is shown as in FIG. 10 which is a cross-sectional view of a ninth embodiment of the logo according to the present invention. The attaching layer 50 is a printed layer and the attaching layer 50 has another adhesive layer 70 adhered thereon. An upper surface of the adhesive layer 70 has another elastic layer 80 and another printed layer 90 printed by the printing inks on an upper surface of the elastic layer 80 to form a multi-layer and three-dimensional logo.

Hence, the logo of the present invention that one side of the logo has a coarse layer 21 to increase the ductility and elasticity of the elastic layer 20 and the elastic layer 20 has better feel. The other side of the logo has an effect layer 30 with various appearances so that the logo can be used in both sides. Also, the logo has ductility and better elasticity so that the logo is not easily damaged while being extended in use. Further, the logo has a certain thickness to provide a three-dimensional effect for the logo.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A logo is printed on a sealed object, comprising:
an adhesive layer with elasticity;
an elastic layer with ductility and elasticity disposed on an upper surface of the adhesive layer; and
a coarse layer disposed on an upper surface of the elastic layer.

2. The logo claimed as in claim 1, wherein the adhesive layer is a hot melt adhesive or a thermoplastic resin.

3. The logo claimed as in claim 1, wherein the elastic layer is printed on the sealed object by melting the adhesive layer in heat.

4. The logo claimed as in claim 1, wherein the elastic layer is a latex, polyurethane (PU), thermoplastic polyurethane (TPU), or silicone.

5. The logo claimed as in claim 1, wherein the coarse layer is a pattern layer with a plurality of patterns.

6. The logo claimed as in claim 1, wherein the coarse layer is a fluff layer with a plurality of fluff.

7. The logo claimed as in claim 1, further comprising an effect layer disposed on a bottom surface of the adhesive layer.

8. The logo claimed as in claim 7, wherein the effect layer is a reflection layer.

9. The logo claimed as in claim 7, wherein the effect layer is a metal plating layer.

10. The logo claimed as in claim 7, wherein the effect layer is a luminous layer.

11. The logo claimed as in claim 7, further comprising an elastic cloth layer disposed between the adhesive layer and the effect layer.

12. The logo claimed as in claim 1, further comprising an effect layer partially disposed on an upper surface of the coarse layer.

13. The logo claimed as in claim 12, wherein the effect layer is a reflection layer.

14. The logo claimed as in claim 12, wherein the effect layer is a metal plating layer.

15. The logo claimed as in claim 12, wherein the effect layer is a luminous layer.

16. A logo is printed on a sealed object, comprising:
an adhesive layer with elasticity;
an elastic layer with ductility and elasticity disposed on an upper surface of the adhesive layer; and
an attaching layer adhered on an upper surface of the elastic layer.

17. The logo claimed as in claim 16, wherein the elastic layer is printed on the sealed object by melting the adhesive layer in heat.

18. The logo claimed as in claim 16, wherein the attaching layer is a shielding paper, reflection layer, metal plating layer, or printed layer.

19. The logo claimed as in claim 18, wherein the printed layer has another adhesive layer adhered on an upper surface thereof, the adhesive layer has another elastic layer disposed on an upper surface thereof, and the elastic layer has another printed layer disposed on an upper surface thereof.

20. The logo claimed as in claim 16, wherein the attaching layer comprises another adhesive layer with elasticity and another elastic layer with ductility and thickness, and the elastic layer is disposed on the upper surface of the adhesive layer.

21. The logo claimed as in claim 20, wherein the attaching layer has another printed layer on an upper surface thereof.

22. The logo claimed as in claim 16, wherein the elastic layer is a latex, polyurethane (PU), thermoplastic polyurethane (TPU), or silicone.

23. The logo claimed as in claim 16, wherein the thickness of the elastic layer is from 0.05 to 2.0 millimeters.
